(19) United States
(12) Patent Application Publication
(10) Pub. No.: US 2014/0184400 A1
(43) Pub. Date: Jul. 3, 2014

(54) VEHICLE SAFETY PRE-WARNING SYSTEM

(71) Applicants: HON HAI PRECISION INDUSTRY CO., LTD., New Taipei (TW); Fu Tai Hua Industry (Shenzhen) Co., Ltd., Shenzhen (CN)

(72) Inventor: REN-JUN YANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/108,353

(22) Filed: Dec. 17, 2013

(30) Foreign Application Priority Data
Dec. 29, 2012 (CN) 2012105885021

(51) Int. Cl. G08G 1/16; B60Q 1/54

(52) U.S. Cl. CPC G08G 1/166; B60Q 1/54
USPC 340/435

(57) ABSTRACT

A vehicle safety pre-warning system mounted on a vehicle, includes a control unit, a first measuring module, a second measuring module, a front info-module, a rear info-module, a warning module, and a rear display module. The first and the second measuring modules are assembled to a front and a rear of the vehicle, respectively. The warning module includes a front warning unit and a rear warning unit. The rear display module is assembled to the rear of the vehicle and includes a warning lamp. The control unit is electrically connected to the above-mentioned various modules.

### BACKGROUND

1. Technical Field

The present disclosure relates to a pre-warning system, and more particularly, to a vehicle safety pre-warning system.

2. Description of Related Art

A vehicle safety pre-warning system is mounted on a vehicle, and includes a control unit, an alarm and a laser distometer. The alarm and the laser distometer are electrically connected to the control unit. The laser distometer measures a distance between the vehicle and another vehicle in front thereof, and sends a distance signal of the measured distance to the control unit. The control unit compares the distance signal to a preset distance value. When the distance signal is less than the preset distance value, the control unit controls the alarm to sound, thereby reminding the driver to brake the vehicle. However, the driver in another vehicle which is behind the vehicle (a rear vehicle) does not know what happens, thus a rear-end collision may be occurred between the vehicle and the rear vehicle.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of three vehicles each equipped with an embodiment of a vehicle safety pre-warning system..

FIG. 2 is diagram of the vehicle safety pre-warning system.

### DETAILED DESCRIPTION

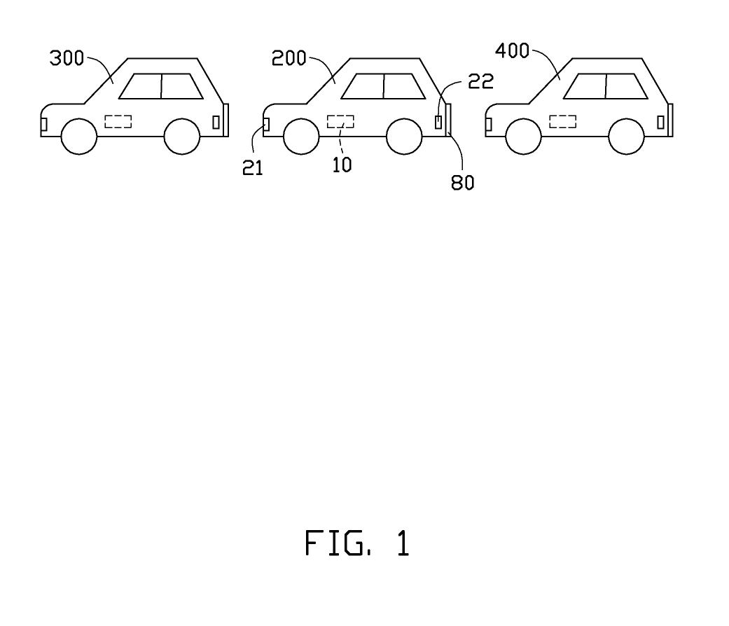

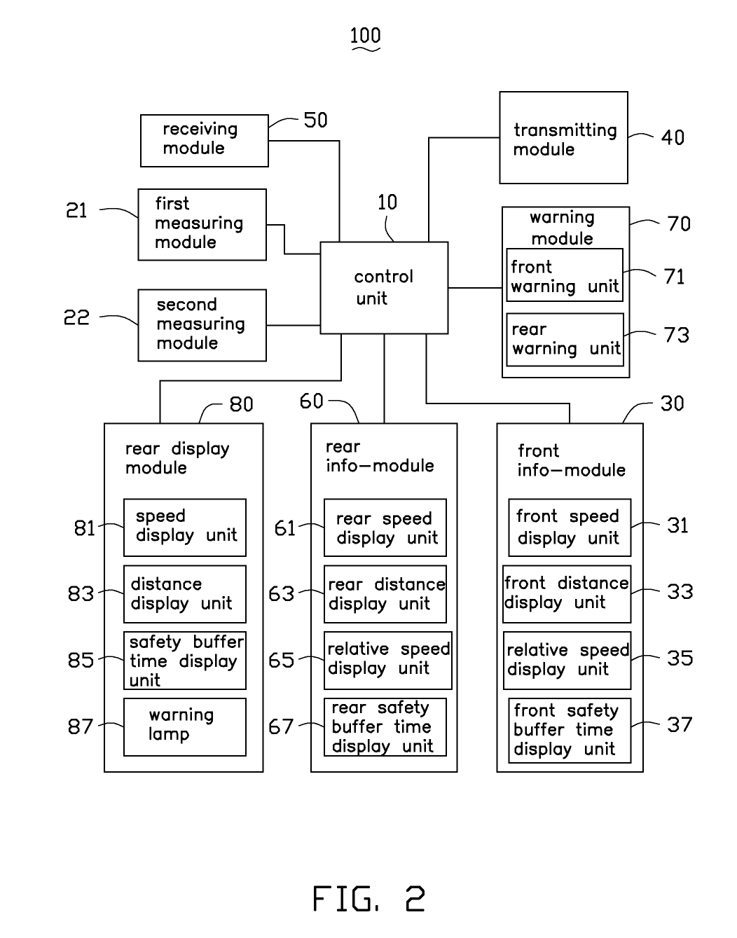

FIGS. 1 and 2 show an embodiment of a vehicle safety pre-warning system 100 mounted on a vehicle 200, for displaying messages of a front vehicle 300 and a rear vehicle 400. The messages includes a speed of the front vehicle 300, a distance between the vehicle 200 and the front vehicle 300, a speed of the rear vehicle 400, a distance between the vehicle 200 and the rear vehicle 400, for example. The vehicle safety pre-warning system 100 displays the messages relating to the rear vehicle 400 on a rear of the vehicle 200. The vehicle safety pre-warning system 100 includes a control unit 10, a first measuring module 21, a second measuring module 22, a front info-module 30, a transmitting module 40, a receiving module 50, a rear info-module 60, a warning module 70, and a rear display module 80. The first measuring module 21, the second measuring module 22, the front info-module 30, the transmitting module 40, the receiving module 50, the rear info-module 60, the warning module 70, and the rear display module 80 are electrically connected to the control unit 10, respectively.

The first measuring module 21 is mounted on a front of the vehicle 200 and electrically connected to the control unit 10, for measuring a distance between the vehicle 200 and the front vehicle 300, measuring the speed of the front vehicle 300, and transmitting the distance value and the speed value to the control unit 10. The control unit 10 figures out a front speed difference and a front safety buffer time based on the speed value of the vehicle 200. The front speed difference is a value of the difference between the speed values of the vehicle 200 and the front vehicle 300. The front safety buffer time is an amount of safety time (allocation duration) value before a rear-end collision would occur or break out between the vehicle 200 and the front vehicle 300, if there is no action taken for preventing such collision. In the embodiment, the first measuring module 21 employs a laser to measure the distance and the speed as above-mentioned.

The second measuring module 22 is mounted on a rear of the vehicle 200 and is electrically connected to the control unit 10, for measuring a distance between the vehicle 200 and the rear vehicle 400, measuring a speed of the rear vehicle 400, and transmitting the distance value and the speed value to the control unit 10. The control unit 10 figures out a rear speed difference and a rear safety buffer time based on the speed of the vehicle 200. The rear speed difference is a value of the difference between the speed values of the vehicle 200 and the rear vehicle 400. The rear safety buffer time is an amount of safety time (allocation duration) before a rear-end collision would occur between the vehicle 200 and the rear vehicle 400, if there is no action to be taken. In the embodiment, the second measuring module 22 employs a laser to measure the distance and speed as mentioned above.

The front info-module 30 is electrically connected to the control unit 10 for receiving messages about or regarding the front vehicle 300 from the control unit 10, and displaying the messages. The front info-module 30 includes a front speed display unit 31, a front distance display unit 33, a relative speed display unit 35 and a front safety buffer time display unit 37, to display various speed information and messages related to the front vehicle 300, the distance between the front vehicle 300 and the vehicle 200, the front speed difference, and the front safety buffer time, respectively. In the embodiment, the front speed display unit 31, the front distance display unit 33, the relative speed display unit 35 and the front safety buffer time display unit 37 are LED displaying units.

The transmitting module 40 is connected to the control unit 10 and communicates with the receiving module 50 mounted on the front vehicle 300. The transmitting module 40 is capable of transmitting the speed value of the vehicle 200, and the distance between the front vehicle 300 and the vehicle 200. In addition, the front speed difference, and the front safety buffer time are transmitted to the receiving module 50 on the front vehicle 300.

The receiving module 50 is connected to the control unit 10 and communicates with the transmitting module 40 mounted on the rear vehicle 400. The receiving module 50 is capable of receiving the speed of the vehicle 300, the distance between the vehicle 200 and the rear vehicle 400, the rear speed difference, and the rear safety buffer time from the transmitting module 40 on the rear vehicle 400.

The rear info-module 60 is electrically connected to the control unit 10 for receiving messages about the rear vehicle 400 from the control unit 10 and displaying such messages. The rear info-module 60 includes a rear speed display unit 61, a rear distance display unit 63, a relative speed display unit 65 and a rear safety buffer time display unit 67 to display the various speed and distance related to the rear vehicle 400. In addition, the distance between the rear vehicle 400 and the vehicle 200, the rear speed difference, and the rear safety buffer time are correspondingly displayed. In the embodiment, the rear speed display unit 61, the rear distance display unit 63, the relative speed display unit 65, and the rear safety buffer time display unit 67 are LED display units.

The warning module 70 is electrically connected to the control unit 10 for reminding the driver in the vehicle 200. The warning module 70 includes a front warning unit 71 and a rear warning unit 73 electrically connected to the control unit 10. A preset safety buffer time is preset and configured in the control unit 10. When the front safety buffer time is less than the preset safety buffer time, the control unit 10 controls the front warning unit 71 to flash and sound alarm. The control unit 10 obtains the rear safety buffer time from the receiving module 50 or figures out the rear safety buffer time basing on measurements from the second measuring module 22, when the rear safety buffer time is less than the preset safety buffer time, the control unit 10 controls the rear warning unit 73 to flash and sound alarm.

The rear display module 80 is mounted on a rear of the vehicle 200, and electrically connected to the control unit 10. The rear display module 80 includes a speed display unit 81, a distance display unit 83, a safety buffer time display unit 85 and a warning lamp 87. The speed display unit 81, the distance display unit 83, the safety buffer time display unit 85 display the speed of the vehicle 200, the distance between the vehicle 200 and the rear vehicle 400, and the rear safety buffer time, respectively, for the driver in the rear vehicle 400 to make or draw reference. When the rear safety buffer time is less than the preset safety buffer time in the control unit 10, the control unit 10 controls the warning lamp 87 to flash, thereby reminding the driver in the rear vehicle 400.

When the front vehicle 300 and the rear vehicle 400 are not equipped with the vehicle safety pre-warning system 100, the transmitting module 40 and the receiving module 50 may be omitted or set to be disabled. The second measuring module 22 obtains the distance between the vehicle 200 and the rear vehicle 400, and the speed of the rear vehicle 400, and transmits the distance and the speed values to the control unit 10. Based on the speed value of the vehicle 200, the control unit 10 figures out the rear speed difference and a rear safety buffer time. In addition, the rear info-module 60 displays the speed of the rear vehicle 400, the distance between the rear vehicle 400 and the vehicle 200, the rear speed difference, and the rear safety buffer time respectively on the rear speed display unit 61. In the embodiment, the rear distance display unit 63, the relative speed display unit 65 and the rear safety buffer time display unit 67 are LED display units.

When driving, the driver in the vehicle 200 supervises or monitors speed and distance information related to the front vehicle 300 and the rear vehicle 400 via the front info-module 30 and the rear info-module 60, respectively. In addition, the driver adjusts the speed of the vehicle 200 to keep or maintain the vehicle 200 under safe operating condition, such as reducing the speed of the vehicle 200 to enable the speed of the vehicle 200 to be less than the speed of the front vehicle 300, or increasing the speed of the vehicle 200 to enable the speed of the vehicle 200 to be greater than the speed of the rear vehicle 400.

When the front safety buffer time is less than the preset safety buffer time, the front warning unit 71 of the vehicle 200, the rear warning unit 73 and the warning lamp 87 of the front vehicle 300 flash and sound alarm. Drivers of the vehicle 200 and the front vehicle 300 take action to avoid the (potential) collision between the vehicle 200 and the front vehicle 300. When the rear safety buffer time is less than the preset safety buffer time, the rear warning unit 73, the warning lamp 87 of the vehicle 200, and the front warning unit 71 of the rear vehicle 400 flashes and sounds alarm. Drivers of the vehicle 200 and the rear vehicle 400 take action to avoid the collision between the vehicle 200 and the rear vehicle 400, as such that the vehicle safety pre-warning system 100 provides an active pre-warning function.

When the front vehicle 300 and the rear vehicle 400 are not equipped with the vehicle safety pre-warning system 100, and if the front safety buffer time is less than the preset safety buffer time, the front warning unit 71 of the vehicle 200 flashes and sounds alarm. The driver of the vehicle 200 takes action to avoid the collision between the vehicle 200 and the front vehicle 300. When the rear safety buffer time is less than the preset safety buffer time, the rear warning unit 73 and the warning lamp 87 flashes and sounds alarm. Drivers of the vehicle 200 and the rear vehicle 400 take action to avoid a collision between the vehicle 200 and the rear vehicle 400.

The vehicle safety pre-warning system 100 sends accurate quantitative messages to the rear display module 80, such that the driver in the rear vehicle 400 is capable of driving safely according to messages displayed by the rear display module 80 of the vehicle 200. When the rear safety buffer time is less than the preset safety buffer time, the rear warning unit 73 and the warning lamp 87 flash and sound alarm. Drivers of the vehicle 200 and the rear vehicle 400 take action to avoid the collision between the vehicle 200 and the rear vehicle 400, such that the vehicle safety pre-warning system 100 provides an active pre-warning function

In other embodiments, the front speed display unit 31, the front distance display unit 33, the relative speed display unit 35, the front safety buffer time display unit 37, the rear speed display unit 61, the rear distance display unit 63, the relative speed display unit 65 and the rear safety buffer time display unit 67 may be not of LED display units, but might be of other lighting units.

The first measuring module 21 and the second measuring module 22 may employ radar to obtains the speeds and distances of the respective vehicles.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A vehicle safety pre-warning system mounted on a vehicle, comprising:
a first measuring module assembled to a front of the vehicle;
a second measuring module assembled to a rear of the vehicle;
a front info-module;
a rear info-module;
a warning module comprising a front warning unit and a rear warning unit;
a rear display module assembled to the rear of the vehicle and comprising a warning lamp; and
a control unit electrically connected to the first measuring module, the second measuring module, the front info-module, the rear info-module, the warning module and the rear display module, respectively;
wherein the first measuring module is configured for measuring a distance between the vehicle and a front vehicle, and measuring a speed of the front vehicle, the first measuring module transmits the distance value and the speed value to the control unit, the control unit figures out a front speed difference which is a value of the difference between the speed values of the vehicle and the front vehicle, and a front safety buffer time which is an amount of safety buffer time value before a collision would breaking out between the vehicle and the front vehicle if there is no action to be taken, the control unit controls the front info-module to display the distance between the vehicle and the front vehicle, the speed of the front vehicle, the front speed difference, and the front safety buffer time; the second measuring module functions the same as the first measuring module but for a rear vehicle, the control unit controls the rear info-module to display the distance and the speed detected by the second measuring module, a rear speed difference, and the rear safety buffer time, the control unit further has a preset safety buffer time, when the front safety buffer time is less than the preset safety buffer time, the control unit controls the front warning unit to warn the driver of the vehicle, when the rear safety buffer time is less than the preset safety buffer time, the control unit controls the rear warning unit to warn the driver of the vehicle, and controls the warning lamp to warn the rear vehicle.

2. The vehicle safety pre-warning system of claim 1, wherein the rear display module further comprises a speed display unit, a distance display unit, and a safety buffer time display unit to respectively display the speed of the vehicle, the distance between the vehicle and the rear vehicle, and the rear safety buffer time, for informing the driver in the rear vehicle.

3. The vehicle safety pre-warning system of claim 1, wherein the front info-module comprises a front speed display unit, a front distance display unit, a relative speed display unit and a front safety buffer time display unit, to display the speed of the front vehicle, the distance between the front vehicle and the vehicle, the front speed difference, and the front safety buffer time, respectively.

4. The vehicle safety pre-warning system of claim 3, wherein the front speed display unit, the front distance display unit, the relative speed display unit and the front safety buffer time display unit are LED displaying units.

5. The vehicle safety pre-warning system of claim 2, further comprising a transmitting module and a receiving module electrically connected to the control unit, respectively, wherein when the front vehicle is equipped with the vehicle safety pre-warning system, the transmitting module on the vehicle communicates with the receiving module on the front vehicle and transmits the speed of the vehicle, the distance between the vehicle and the front vehicle, the front speed difference, and the front safety buffer time to the receiving module on the front vehicle, when the front safety buffer time is less than the preset safety buffer time, the control unit on the front vehicle controls the rear warning unit of the front vehicle to warn the driver of the vehicle.

6. The vehicle safety pre-warning system of claim 5, wherein when the rear vehicle is equipped with the vehicle safety pre-warning system, the receiving module on the vehicle communicates with the transmitting module on the rear vehicle and receives the speed of the rear vehicle, the distance between the vehicle and the rear vehicle, the rear speed difference, and the rear safety buffer time from the transmitting module on the rear vehicle and transmits the speed of the rear vehicle, the distance between the vehicle and the rear vehicle, the rear speed difference, and the rear safety buffer time to the control unit of the vehicle to be displayed on the rear info-module of the vehicle.

7. The vehicle safety pre-warning system of claim 1, wherein the rear info-module comprises a rear speed display unit, a rear distance display unit, a relative speed display unit and a rear safety buffer time display unit, to display the speed of the rear vehicle, the distance between the rear vehicle and the vehicle, the rear speed difference, and the rear safety buffer time, respectively.

8. The vehicle safety pre-warning system of claim 7, wherein the rear speed display unit, the rear distance display unit, the relative speed display unit and the rear safety buffer time display unit are LED displaying units.

9. The vehicle safety pre-warning system of claim 1, wherein the first measuring module employs a laser or a radar to measure the speed and the distance of the front vehicle, and the second measuring module employs a laser or a radar to measure the speed and the distance of the rear vehicle.

10. A vehicle safety pre-warning system mounted on a vehicle, comprising:
a first measuring module;
a second measuring module;
a front info-module;
a rear info-module;
a warning module comprising a front warning unit and a rear warning unit;
a rear display module assembled to the rear of the vehicle; and
a control unit electrically connected to the first measuring module, the second measuring module, the front info-module, the rear info-module, the warning module and the rear display module, respectively;
wherein the first measuring module is configured for measuring a distance between the vehicle and a front vehicle, and measuring a speed of the front vehicle, the first measuring module transmits the distance value and the speed value to the control unit, the control unit figures out a front speed difference which is a value of the difference between the speed value of the vehicle and the speed value of the front vehicle, and a front safety buffer time which is an amount of safety buffer time value before a collision is breaking out between the vehicle and the front vehicle if there is no action to be taken, the control unit controls the front info-module to display the distance between the vehicle and the front vehicle, the speed of the front vehicle, the front speed difference, and the front safety buffer time; the second measuring module functions the same as the first measuring module but for a rear vehicle, the control unit controls the rear info-module to display the distance and the speed detected by the second measuring module, a rear speed difference, and the rear safety buffer time, and controls the rear display module to display the speed of the vehicle, the distance detected by the second measuring module, and the rear safety buffer time, the control unit further has a preset safety buffer time, when the front safety buffer time is less than the preset safety buffer time, the control unit controls the front warning unit to warn the driver in the vehicle, when the rear safety buffer time is less than the preset safety buffer time, the control unit controls the rear warning unit to warn the drivers of the vehicle and the rear vehicle, respectively.

11. The vehicle safety pre-warning system of claim 10, wherein the rear display module further comprises a speed display unit, a distance display unit, and a safety buffer time display unit to respectively display the speed of the vehicle, the distance between the vehicle and the rear vehicle, and the rear safety buffer time, for informing the driver in the rear vehicle.

12. The vehicle safety pre-warning system of claim 10, wherein the front info-module comprises a front speed display unit, a front distance display unit, a relative speed display unit and a front safety buffer time display unit, to respectively display the speed of the front vehicle, the distance between the front vehicle and the vehicle, the front speed difference, and the front safety buffer time.

13. The vehicle safety pre-warning system of claim 12, wherein the front speed display unit, the front distance display unit, the relative speed display unit and the front safety buffer time display unit are LED displaying units.

14. The vehicle safety pre-warning system of claim 11, further comprising a transmitting module and a receiving module electrically connected to the control unit, wherein when the front vehicle is equipped with the vehicle safety pre-warning system, the transmitting module on the vehicle communicates with the receiving module on the front vehicle and transmits the speed of the vehicle, the distance between the vehicle and the front vehicle, the front speed difference, and the front safety buffer time to the receiving module on the front vehicle, when the front safety buffer time is less than the preset safety buffer time, the control unit on the front vehicle controls the rear warning unit of the front vehicle to warn the drivers of the front vehicle and the vehicle, respectively.

15. The vehicle safety pre-warning system of claim 14, wherein when the rear vehicle is equipped with the vehicle safety pre-warning system, the receiving module on the vehicle communicates with the transmitting module on the rear vehicle and receives the speed of the rear vehicle, the distance between the vehicle and the rear vehicle, the rear speed difference, and the rear safety buffer time from the transmitting module on the rear vehicle and transmits the speed of the rear vehicle, the distance between the vehicle and the rear vehicle, the rear speed difference, and the rear safety buffer time to the control unit of the vehicle to be displayed on the rear info-module of the vehicle.

16. The vehicle safety pre-warning system of claim 10, wherein the rear info-module comprises a rear speed display unit, a rear distance display unit, a relative speed display unit and a rear safety buffer time display unit, to display the speed of the rear vehicle, the distance between the rear vehicle and the vehicle, the rear speed difference, and the rear safety buffer time, respectively.

17. The vehicle safety pre-warning system of claim 16, wherein the rear speed display unit, the rear distance display unit, the relative speed display unit and the rear safety buffer time display unit are LED displaying units.

18. The vehicle safety pre-warning system of claim 10, wherein the first measuring module employs a laser or a radar to measure the speed and the distance of the front vehicle, and the second measuring module employs a laser or a radar to measure the speed and the distance of the rear vehicle.

19. The vehicle safety pre-warning system of claim 10, wherein the rear display module further comprises a warning lamp electrically connected to the control unit, when the rear safety buffer time is less than the preset safety buffer time, the control unit controls the warning lamp to warn the rear vehicle.

20. The vehicle safety pre-warning system of claim 1, wherein the first measuring module and the second measuring unit are assembled to the front and the rear of the vehicle, respectively.
